(19) United States
(12) Patent Application Publication
(10) Pub. No.: US 2026/0299141 A1
(43) Pub. Date: Oct. 1, 2026

(54) SYSTEM AND METHOD FOR ESTIMATING LOCALIZATION OF A VEHICLE

(71) Applicant: Continental Autonomous Mobility Germany GmbH, Ingolstadt (DE)

(72) Inventors: Gunnery Srinath, Tirupati (IN); Ramaprakash Bayadi, Bengaluru (IN); Bethi Pardhasaradhi, Visakhapatnam (IN)

(73) Assignee: Continental Autonomous Mobility Germany GmbH, Ingolstadt (DE)

(21) Appl. No.: 19/093,801

(22) Filed: Mar. 28, 2025

(51) Int. Cl. G01S 19/48

(52) U.S. Cl. CPC G01S 19/48

(57) ABSTRACT

A method and system for estimating localization of a vehicle is disclosed. One or more route attributes are obtained from navigation data providing route information with respect to the vehicle's navigation on a route. The vehicle's kinematic state information is received with respect to the vehicle's navigation on the route from one or more sensors. Virtual route boundaries are generated on a route model based on obtained one or more road attributes and a plurality of particles are generated on the route model, each particle representing a hypothetical vehicle state on the route. Weights are assigned to the plurality of particles according to one or more trajectory constraints associated with the navigation of the vehicle, and the localization of the vehicle is estimated based on a set of weighted particles from the plurality of weighted particles.

### FIELD OF THE INVENTION

The present disclosure in general relates to position determination of a vehicle. More particularly, it relates to a system and a method for estimating localization of the vehicle.

### BACKGROUND OF THE INVENTION

Vehicle localization technology refer to methods and systems used to determine precise location and orientation of a vehicle within its surroundings. The vehicle localization technology is important for navigation purposes, for example, in context of autonomous vehicles, where accurate and reliable location information is essential for safe and effective operation and navigation of the vehicle.

Most vehicles use Global Navigation Satellite System (GNSS) to determine a position of the vehicle. However, availability of the GNSS is not always constant and accuracy of the GNSS may also deteriorate by multi-path interference under conditions of poor visibility and closed environments leading to inaccuracies in location data and reduced reliability. In conventional art, at GNSS denied environments, Inertial Measurement Units (IMUs), such as accelerometers or Gyroscopes, are preferred for navigation. However, small measurement errors from sensors are inevitable which leads to increase in error or causes drift in a calculated position and orientation over time, thus solutions using the IMUs may affect navigational accuracy and safety of the vehicle.

Thus, there is a need for an improved solution that is capable of solving the aforementioned problems of conventional localization systems.

### SUMMARY OF THE INVENTION

Although Global Navigation Satellite System (GNSS) based navigation systems are widely used for a vehicle's localization, in regions where GNSS is unavailable, a localization system may need to rely on other sources such as inertial measurement units. However, in existing solutions, Inertial Measurement Units (IMUs) depend on previous positions. As the vehicle moves forward, subsequent movement are based on the previous positions, leading to divergence.

Therefore, there is a need for an improved system and method for estimating a vehicle's localization, for example, in an event of GNSS inaccessible regions. Moreover, there is a resilient need for improving accuracy of the vehicle's localization in an event of dead reckoning.

It is therefore an aspect of the present disclosure to provide a system and method for estimating a localization of a vehicle using one or more trajectory constraints in a driving route or trajectory of the vehicle.

This and other aspects are achieved by means of a system, a method, a computer program and a computer-readable medium defined in the appended claims. The term exemplary is in the present context to be understood as serving as an instance, example or illustration.

According to an aspect of the present disclosure, a method for estimating a localization of a vehicle localization is disclosed. The method comprising obtaining one or more route attributes from navigation data providing route information with respect to the vehicle's navigation on the route and receiving information on the vehicle's kinematic state with respect to the vehicle's navigation on the route from one or more sensors. Further, generating virtual route boundaries on a route model based on the obtained one or more route attributes and the vehicle's kinematic information and generating a plurality of particles on the route model, each particle representing a hypothetical vehicle state on the route. The method further comprises assigning weight to each particle according to one or more trajectory constraints associated with the navigation of the vehicle and estimating the vehicle's localization based on a set of weighted particles from the plurality of weighted particles, wherein the set of weighted particles are constrained within the virtual route boundaries.

Optionally, the one or more trajectory constraints comprises at least one of: lateral route width constraint generated from the navigation data, longitudinal velocity constraint generated from the information on the vehicle's kinematic state, and global navigation satellite system.

Optionally, the one or more route attributes comprise the route's centreline shape points, a width of the route, lane marking on the route, surface type of the route, a number of lanes on the route, edges and curvature data associated with the route.

Optionally, the navigation data is a semantic map data comprises at least one of lane markings, road geometry and traffic rules and the information on the kinematic state comprises: a rate of change of at least one of: a position, velocity and orientation of the vehicle navigating on the road.

Optionally, the set of particles constrained within the virtual route boundaries are assigned higher weights with respect to other particles from the plurality of particles, wherein the other particles comprise particles positioning the vehicle beyond the virtual road boundaries and are assigned lower weights with respect to set of particles.

Optionally, updating in real time, the virtual road boundaries with respect to a change in at least one of the navigation data and vehicle's kinematic information.

Optionally, the virtual road boundaries are generated by polyfitting the obtained one or more route attributes.

According to another aspect of the present disclosure, the system for estimating a localization of a vehicle is disclosed. The system comprises of a processing circuitry configured to obtain, one or more route attributes from navigation data providing route information with respect to the vehicle's navigation on the route and receive information on the vehicle's kinematic state with respect to the vehicle's navigation on the route from one or more sensors. The processing circuitry is configured to generate virtual route boundaries on a route model based on the obtained one or more route attributes and the vehicle's kinematic information and generate a plurality of particles on the route model, each particle representing a hypothetical vehicle state on the route. Further, processing circuitry is configured to assign weights to the plurality of particles according to one or more trajectory constraints associated with the navigation of the vehicle and estimate the vehicle's localization based on a set of weighted particles from the plurality of weighted particles, wherein the set of weighted particles are constrained within the virtual route boundaries.

Optionally, the processing circuitry is further arranged to assign to the set of particles constrained within the virtual route boundaries, higher weights with respect to other particles from the plurality of particles, in which the other particles position the vehicle beyond the virtual road boundaries are assigned lower weights with respect to set of particles.

According to another aspect of the present disclosure, there is provided a computer program when loaded and run on a system, causes a processing circuitry to perform corresponding steps of method for estimating a vehicle's localization.

According to another aspect of the present disclosure, there is provided a computer-readable medium having stored thereon a computer program.

Some embodiments disclosed herein have one or more of the following advantages:
The proposed system and method significantly improve accuracy of the vehicle's localization in regions where Global Navigation Satellite System (GNSS) is unavailable.
The proposed method and system utilizes the route attributes such lane markings and road geometry as lateral constraints and vehicle kinematics information from Inertial Measurement Units (IMU) sensor as longitudinal constraints for precise localization of the vehicle.
The proposed system and method facilitate localization of the vehicle even in GNSS inaccessible regions and eliminates drifts in the positioning of the vehicle in comparison with dead reckoning based approach (generally used approach in GNSS denied environments).

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example scenario illustrating limitations in Global Navigation Satellite System (GNSS) in unavailable regions, according to state of the art;

FIG. 2 discloses a block diagram of a system for estimating a localization of a vehicle, according to some embodiments herein;

FIG. 3 illustrates a flow chart for a method for estimating the localization of the vehicle, according to some embodiments herein;

FIG. 4 discloses an example illustrating assignment of particle weighting for estimating the localization of the vehicle, according to some embodiments herein; and

FIG. 5 illustrates an example-computing environment implementing the system, as shown in FIG. 2, according to some embodiments herein.

### DETAILED DESCRIPTION

Aspects of the present disclosure will be described more fully hereinafter with reference to the accompanying drawings. The systems and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit aspects of the invention. It should be emphasized that the term“comprises/comprising” when used in this specification is taken to specify the presence of stated features, integers, steps, or components, but does not preclude the presence or addition of one or more other features, integers, steps, components, or groups thereof. As used herein, the singular forms“a”,“an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a system and a method, it may also be embodied in one or more processors and one or more memories coupled to the one or more processors, wherein the one or more memories store one or more programs that perform the steps, services and functions disclosed herein when executed by the one or more processors.

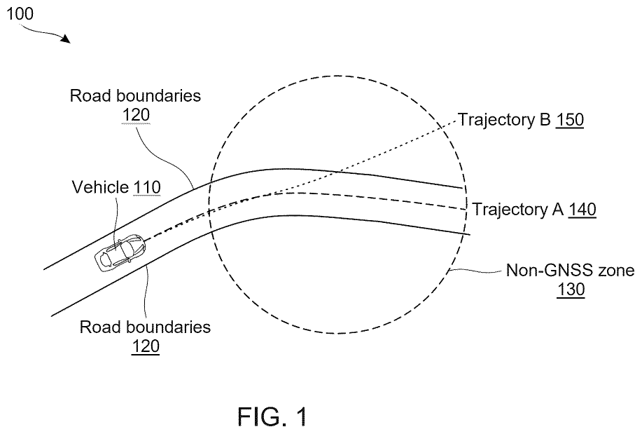

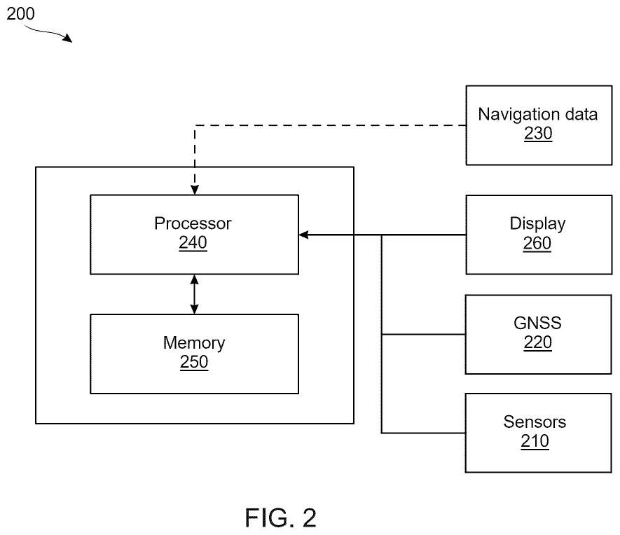

In an example of describing the conventional art, FIG. 1 shows a representation 100 illustrating the limitations in a Non-Global Navigation Satellite System (GNSS) zones or regions 130. The vehicle 110 is navigating on a road delineated by road boundaries 120. The road boundaries 120 define permissible limits within which the vehicle 110 is to be operated. Initially, in the GNSS-available zone, the vehicle 110 follows Trajectory A 140, which represents a path determined by GNSS data. As the vehicle 110 advances and enters the non-GNSS zone 130, the unavailability of GNSS signals leads to be dependent on other information sources, such as kinematic information from sensors 210 (shown later in FIG. 2) and road boundaries 120 from navigation data and thus depends on other sources (for example additional sensors) for controlling the navigation of the vehicle 110.

Also referring to FIG. 1, when the vehicle 110 advances without relying on GNSS 220 (shown later in FIG. 2), the navigation of the vehicle 110 results in the diverging to Trajectory B 150. The divergence to Trajectory B 150 is due to estimation of the vehicle's 110 current position based on a previously determined position, and subsequently advancing based on previous positions based on IMU and gyroscope measurements only, which is also known as dead reckoning. The Trajectory B 150 illustrates the output of vehicle 110 position estimation in absence of GNSS guidance.

In the present disclosure, a system 200 and a method 300 are provided to for use when the vehicle 110 navigates in absence of the GNSS 220.

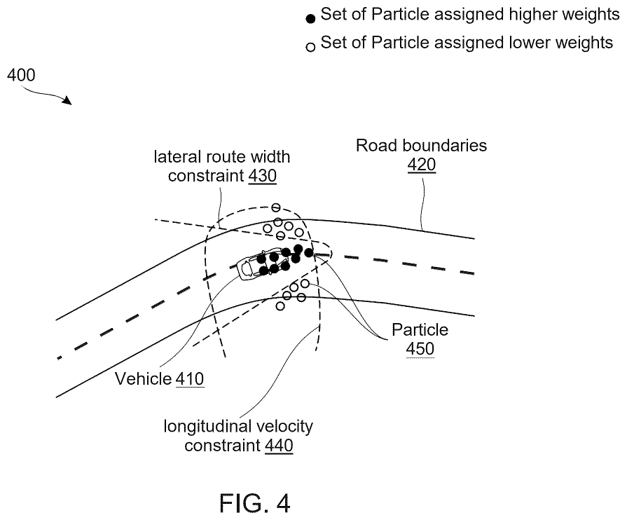

In an embodiment, FIG. 2 discloses a block diagram of the system 200 for estimating a localization of a vehicle 410 (shown later in FIG. 4). In an example, the system 200 may be configured in the vehicle 410. The vehicle 410 comprises one or more sensors 210. The system 200 comprises processing circuitry or processor 240 with memory 250, and the system 200 via the processing circuitry 240 may be coupled to a display/interface unit 260. The processing circuitry 240 may be communicatively coupled to the one or more sensors 210, memory unit 250 and display unit 260. In another aspect, the processing circuitry 240 may be commutatively coupled to the Global Navigational Satellite System (GNSS) 220.

The system 200 for estimating the localization of the vehicle 410 (also referred as vehicle's localization) comprises the processing circuitry 240 configured to obtain one or more route attributes (interchangeable used as road attributes) from navigation data 230 providing route information with respect to the vehicle 410's navigation on a road or route. The processing circuitry 240 may be configured to receive information on the vehicle 410's kinematic state with respect to the vehicle 410's navigation on the route from the one or more sensors 210. The processing circuitry 240 may generate virtual route boundaries on a route model based on the obtained one or more route attributes and the vehicle's kinematic information. The processing circuitry 240 may be configured to generate a plurality of particles 450 (shown later in FIG. 4) on the route model, each particle 450 representing a hypothetical vehicle 410 state on the route. Further, the processing circuitry 240 may be configured to assign weights to the plurality of particles 450 according to one or more trajectory constraints associated with the navigation of the vehicle 410. The processing circuitry 240 may be configured to estimate the vehicle 410's localization based on a set of weighted particles from the plurality of weighted particles. The set of weighted particles are constrained within the virtual route boundaries.

In an example, the vehicle 410 comprises a four-wheeler, however, the vehicle 410 may also comprise a two-wheeler, a three-wheeler, the four-wheeler for example, a car of different type like hatchback, sedan etc., or a truck or any other four-wheeler automobile.

Referring to FIG. 2, in an aspect of the present invention, the processing circuitry 240 is communicatively linked and configured to receive navigation data 230 through a wireless communication means (not shown). In one embodiment, the navigation data 230 may be stored in a server (not shown). The wireless communication means may be technology utilized for data transmission like Radio Frequency (RF) communication, satellite communication, Light Fidelity (Li-Fi), Wireless Fidelity (Wi-Fi), Global System for Mobile Communications (GSM) and cellular communication such as 2G, 3G, 4G LTE, and 5G networks.

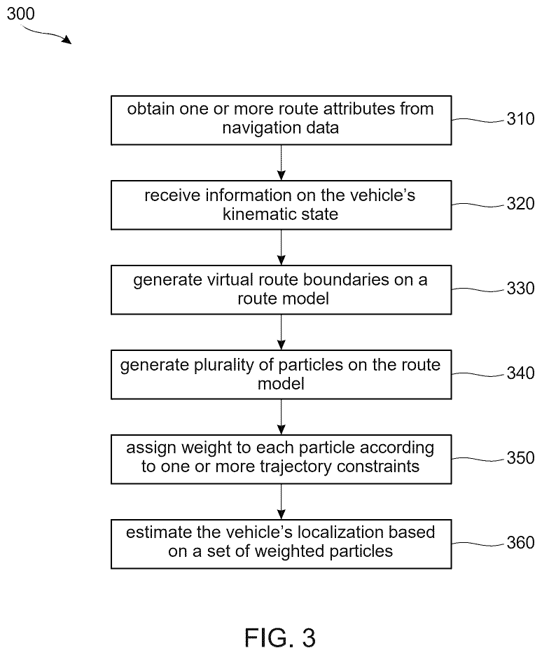

Referring to FIG. 3, a flow chart for a method 300 for estimating the localization of the vehicle 410 is shown. The method 300 at step 310 comprises obtaining the one or more route attributes from the navigation data 230 providing the route information with respect to the navigation of the vehicle 410 on the route.

At step 320, the method 300 comprises receiving information on the vehicle's kinematic state with respect to the vehicle' 410s navigation on the route. At step 330, the method 300 provides generating the virtual route boundaries on the route model based on the obtained one or more route attributes and the vehicle's kinematic information.

At step 340, the method 300 provides generating the plurality of particles 450 on the route model, each particle 450 representing the hypothetical vehicle 410's state on the route, and at step 350, the method 300 provides assigning weight to each particle 450 according to the one or more trajectory constraints associated with the navigation of the vehicle 410.

At step 360, the method 300 provides estimating the localization of the vehicle 410 based on the set of weighted particles from the plurality of weighted particles in which the set of weighted particles are constrained within the virtual route boundaries.

In an embodiment, the virtual road boundaries are generated by polyfitting (Curve-fitting) the obtained one or more route attributes.

In an example, the polyfitting is a process of collecting data from various route attributes such as curvature, lane width, and road geometry are collected. A polynomial function is used to fit the data obtained from the route attributes which is then analysed to create a model which dynamically generates virtual road boundaries based on the road characteristics.

In an example, Bezier curves may also be used for creating equations for curves from collected data associated with route attributes.

In a further example, road characteristics are parameters that describe the road, such as road width, number of lanes, surface type, boundaries, lane markers, road edges and curvature data.

Referring to FIG. 2 and FIG. 3, in an embodiment, the one or more trajectory constraints comprises at least one of: lateral route width constraint 430 generated from the navigation data, longitudinal velocity constraint 440 generated from the information on the vehicle 410's kinematic state, and global navigational satellite system 220.

In an example, the system 200 and method 300 adaptively estimates the vehicle 410's location even when GNSS 220 signals are unavailable, by utilizing only the lateral route width constraint 430 and the longitudinal velocity constraint 440. The system 200 and method 300 determines the non-availability of GNSS 220 signals if the system 200 and the method 300 does not receive any signals from the GNSS 220.

In an example, the trajectory is a path or direction in which the vehicle 410 is constrained by one or more trajectory constraints. One constraint is the lateral route width constraint 430, which is determined from the navigation data 230 and defines the permissible lateral movement within the road boundaries. Another constraint is the longitudinal velocity constraint 440, derived from the vehicle 410's kinematic information, such as its speed and acceleration received from the one or more sensors 210.

In an embodiment, the one or more route attributes comprise the route's centreline shape points, a width of the route, lane marking on the route, surface type of the route, a number of lanes on the route, edges and curvature data associated with the route.

In an example, the route model refers to a detailed map of the road using route attributes to accurately determine the road boundary conditions. The attributes comprise the route's specific points that indicates the central path of the road, measurement of road width, lane markings in the roadsides, the type of surface such as asphalt or concrete, the number of lanes, and details on the route's edges and curvature. Based on the route model, the virtual route boundaries are generated.

In an embodiment, the navigation data 230 is a semantic map data comprises at least one of lane markings, road geometry and traffic rules.

In an example, the navigation data 230 stored in the server and received by the vehicle 410 might be accessed by the system 200 and method 300 for retrieving information such as navigation information, information from Geographic information systems (GIS), and Location-Based Services (LBS) and semantic navigation data 230, for example, geographic areas, routes, landmarks and any meaningful geometric data describing the characteristics of the road where the vehicle 410 is navigating.

In an embodiment, the information on the kinematic state comprises: a rate of change of at least one of: a position, velocity and orientation of the vehicle 170 navigating on the road.

In an example, the one or more sensors 210 comprise Inertial Measurement Units (IMUs), such as accelerometers and gyroscopes, which measure linear acceleration and rotational values. Further, the sensors 210 further comprises monitoring units such as Radio Detection and Ranging, cameras, and Light Detection and Ranging, which measure data about the environment. The sensed data is used to calculate the vehicle's velocity, orientation, and trajectory in real-time using particle filter framework.

Moreover, the one or sensors 210 are strategically mounted around the vehicle 410 to collect kinematic data. The sensors 210 are positioned at various locations, such as the front, rear, and sides of the vehicle 410, to ensure three-dimensional coverage of the vehicle 410's motion and orientation during navigation which is referred as kinematic state of the vehicle 410.

In an embodiment, the processing circuitry 240 is further arranged to assign higher weights to the set of particles constrained within the virtual route boundaries, with respect to other particles from the plurality of particles 450. The other particles positioning the vehicle beyond the virtual road boundaries are assigned lower weights with respect to set of particles or as compared to the set of particles 450.

In an example, particles 450 refer to hypothetical vehicle 410's state estimations where each particle 450 denotes a possible state or position of the vehicle 410 within the generated virtual route boundaries. The processing circuitry 240 is configured to evaluate each particle 450's position relative to these boundaries. A set of particles 450 refer to a group of one or more particles 450. The set of particles 450 that fall within the virtual route boundaries are assigned with higher weights as they represent more likely positions of the vehicle 410. On the other hand, the set of particles 450 that position the vehicle 410 outside these boundaries are assigned lower weights, indicating less probability of accuracy.

In a further example, higher weights and lower weights are measurable indicators used to estimate the positional accuracy of the vehicle 410. In simple terms, higher weights indicate a greater probability of accuracy for the estimated position of the vehicle 410, while and lower weights indicate a lesser probability of accuracy for the estimated position of the vehicle 410.

In an embodiment, the processing circuitry 240 is further arranged to update in real time, the virtual road boundaries with respect to a change in at least one of the navigation data 230 and vehicle's kinematic information.

In an example, if the speed of the vehicle 410 increases or it changes direction, the processing circuitry 240 updates the virtual boundaries generated in the display unit 260 in real-time to reflect the updated direction of the vehicle 410.

In another embodiment, resampling a new set of particles 450 for subsequent prediction is performed, if the estimated particles 450 fall below a certain threshold level of alignment with the lateral route width constraint 430 and longitudinal velocity constraint 440.

In another aspect, FIG. 4 describes an embodiment 400 illustrating the assignment of particle weighting by the system 200 and the method 300. As shown in FIG. 4, the vehicle 410 is navigating through the specified road boundaries 420. The movement of the vehicle 410 is continuously monitored by the system 200 by utilizing one or more type of constraints such as lateral route width constraint 430 and longitudinal velocity constraint 440. The lateral route width constraint 430 is derived from navigation data 230 which defines the permissible lateral movement within the road's boundaries 420. The lateral route width constraint 430 ensures that the estimation of the vehicle 410's location does not go beyond the permissible road width boundary 420. On the other hand, the longitudinal velocity constraint 440 is based on kinematic information such as vehicle 410's current speed and acceleration derived from one or more sensors 210.

Also in the FIG. 4, the system 200 utilizes particle filtering where each particle 450 represents a predictable hypothetical vehicle 410's state or position of the vehicle 410 within the virtual route boundaries by using the constraints of lateral route width constraint 430 and longitudinal velocity constraint 440. The processing circuitry 240 of the system 200 and method 300 evaluates each particle's 450 hypothetical vehicle 410's state or position in relative to the one or more type of constraints within the generated virtual road boundaries.

In an example, in the event of GNSS inaccessible regions, the set of particles 450 which align with both lateral route width constraint 430 and longitudinal velocity constraint 440 receive higher weights indicating a higher probability of accurately representing the vehicle 410's position. In contrary, the set of particles 450 which does not align with both lateral route width constraint 430 and longitudinal velocity constraint 440 or align with only either one of the constraints receive lower weights indicating a lower probability of accuracy.

Based on the set of higher weighted particles from the plurality of weighted particles, the system 200 and method 300 estimates the localization of vehicle 410 and displays the predicted location in the display unit 260.

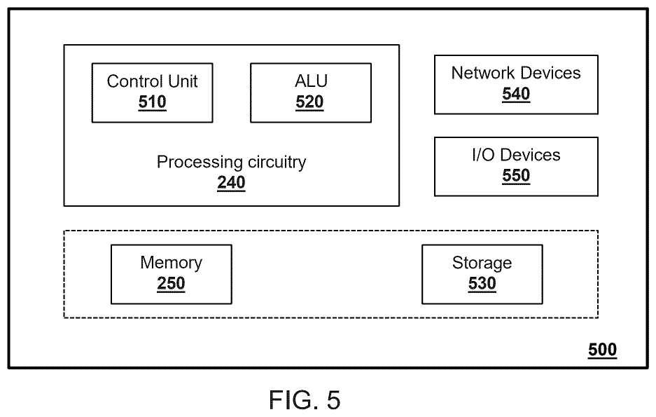

FIG. 5 illustrates an example-computing environment 500 implementing the system 200 and method 300, as shown in FIGS. 2 and 3 for estimating the localization of vehicle 410, according to some embodiments herein. As depicted in FIG. 5, the computing environment 500 comprises at least one data processing circuitry 240 that is equipped with a control unit 510 and an Arithmetic Logic Unit (ALU) 520, a plurality of networking devices 540 and a plurality Input output, I/O devices 550, a memory 250, a storage 530. The data processing circuitry 240 may be responsible for implementing the system 200 and method 300 described in FIGS. 2 to 3. For example, the data processing circuitry 240 in some embodiments be equivalent to the processing circuitry 240 of the system 200 as described above in reference with FIG. 2. The data processing circuitry 240 is capable of executing software instructions stored in memory 250. The data processing circuitry 240 receives commands from the control unit 510 in order to perform its processing. Further, any logical and arithmetic operations involved in the execution of the instructions are computed with the help of the ALU 520.

The computer program is loadable into the data processing circuitry 240, which may, for example, be comprised in an electronic apparatus (such as the platform). When loaded into the data processing circuitry 240, the computer program may be stored in the memory 250 associated with or comprised in the data processing circuitry 240. According to some embodiments, the computer program may, when loaded into and run by the data processing circuitry 240, cause execution of method steps according to, for example, any of the methods illustrated in FIG. 3 as described herein.

The overall computing environment 500 may be composed of multiple homogeneous and/or heterogeneous cores, multiple CPUs of different kinds, special media and other accelerators. Further, the plurality of data processing circuitry 240 may be located on a single chip or over multiple chips.

The algorithm comprising of instructions and codes required for the implementation are stored in either the memory 250 or the storage 530 or both. At the time of execution, the instructions may be fetched from the corresponding memory 250 and/or storage 530 and executed by the data processing circuitry 240.

In case of any hardware implementations various networking devices 540 or external I/O devices 550 may be connected to the computing environment to support the implementation through the networking devices 540 and the I/O devices 550.

The embodiments disclosed herein can be implemented through at least one software program running on at least one hardware device and performing network management functions to control the elements. The elements shown in FIG. 5 include blocks which can be at least one of a hardware device, or a combination of hardware device and software module.

### Reference signs

System 200
One or more sensors 210
GNSS 220
Navigation data 230
Processing circuitry 240
Memory 250
Display unit 260
Method 300
Vehicle 410
Road boundaries 420
lateral route width constraint 430 and
longitudinal velocity constraint 440
Computing environment 500
Control unit 510
Arithmetic Logic Unit (ALU) 520
Storage 530
Networking devices 540
Input/output devices 550

1. A method for estimating a localization of a vehicle, the method comprising:
obtaining one or more route attributes from navigation data providing route information with respect to the vehicle's navigation on the route;
receiving information on the vehicle's kinematic state with respect to the vehicle's navigation on the route from one or more sensors;
generating virtual route boundaries on a route model based on the obtained one or more route attributes;
generating a plurality of particles on the route model, each particle representing a hypothetical vehicle state on the route;
assigning weight to each particle according to one or more trajectory constraints associated with the navigation of the vehicle; and
estimating the localization of vehicle based on a set of weighted particles from the plurality of weighted particles, wherein the set of weighted particles are constrained within the virtual route boundaries.

2. The method according to claim 1, wherein the one or more trajectory constraints comprises at least one of: a lateral route width constraint generated from the navigation data, a longitudinal velocity constraint generated from the information on the vehicle's kinematic state, and a Global Navigational Satellite System.

3. The method according to claim 1, wherein the one or more route attributes comprise the route's centreline shape points, a width of the route, lane marking on the route, surface type of the route, a number of lanes on the route, edges and curvature data associated with the route.

4. The method according to claim 1, wherein the navigation data is a semantic map data comprising at least one of lane markings, road geometry and traffic rules; and
wherein the information on the kinematic state comprises: a rate of change of at least one of: a position, velocity and orientation of the vehicle navigating on the road.

5. The method according to claim 1, wherein the set of particles constrained within the virtual route boundaries are assigned higher weights with respect to other particles from the plurality of particles, wherein the other particles comprises particles positioning the vehicle beyond the virtual road boundaries and are assigned lower weights with respect to set of particles.

6. The method according to claim 1, comprising:
updating in real time, the virtual road boundaries with respect to a change in at least one of the navigation data and vehicle's kinematic information.

7. The method according to claim 1, wherein the virtual road boundaries are generated by polyfitting the obtained one or more route attributes.

8. A system for estimating a localization of a vehicle, the system comprising:
processing circuitry configured to:
obtain, one or more route attributes from navigation data providing route information with respect to the vehicle's navigation on the route;
receive information on the vehicle's kinematic state with respect to the vehicle's navigation on the route from one or more sensors;
generate virtual route boundaries on a route model based on the obtained one or more route attributes;
generate a plurality of particles on the route model, each particle representing a hypothetical vehicle's state on the route;
assign weights to each particle according to one or more trajectory constraints associated with the navigation of the vehicle; and
estimate localization of the vehicle based on a set of weighted particles from the plurality of weighted particles, wherein the set of weighted particles are constrained within the virtual route boundaries.

9. The system according to claim 8, wherein the one or more trajectory constraints comprises at least one of: lateral route width constraint generated from the navigation data, longitudinal velocity constraint generated from the information on the vehicle's kinematic state, and Global Navigation Satellite System.

10. The system according to claim 8, wherein the one or more route attributes comprise the route's centreline shape points, a width of the route, lane marking on the route, surface type of the route, a number of lanes on the route, edges and curvature data associated with the route.

11. The system according to claim 8, wherein the navigation data is a semantic map data comprising at least one of lane markings, road geometry and traffic rules; and
wherein the information on the kinematic state comprises: a rate of change of at least one of: a position, velocity and orientation of the vehicle navigating on the road.

12. The system according to claim 8, the processing circuitry is further arranged to:
assign to the set of particles constrained within the virtual route boundaries, higher weights with respect to other particles from the plurality of particles, wherein the other particles position the vehicle beyond the virtual road boundaries are assigned lower weights with respect to set of particles.

13. The system according claim 8, wherein the processing circuitry is further arranged to:
update in real time, the virtual road boundaries with respect to a change in at least one of the navigation data and vehicle's kinematic information.

14. A computer program comprising instructions which, when the program is executed by a computer, cause the computer to carry out a method of claim 1.

15. A non-transitory computer-readable medium having stored thereon the computer program of the claim 14.

16. The system according to claim 9, wherein the one or more route attributes comprise the route's centreline shape points, a width of the route, lane marking on the route, surface type of the route, a number of lanes on the route, edges and curvature data associated with the route.

17. The method according claim 2, wherein the one or more route attributes comprise the route's centreline shape points, a width of the route, lane marking on the route, surface type of the route, a number of lanes on the route, edges and curvature data associated with the route.
